(19) United States
(12) Patent Application Publication
(10) Pub. No.: US 2005/0157954 A1
(43) Pub. Date: Jul. 21, 2005

(54) Context-aware device

(76) Inventor: Esko Olavi Dijk, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/511,368

(22) PCT Filed: Apr. 1, 2003
(86) PCT No.: PCT/IB03/01376

(30) Foreign Application Priority Data
Apr. 19, 2002 (EP) 02076547.5

(51) Int. Cl. G06K 7/10

(52) U.S. Cl. 382/321

(57) ABSTRACT

A device (100) arranged for context-aware operations, comprising a light sensor (101) for registering incident light (120) originating from an external light source (111), coupled to filtering means (102) for extracting specific frequency components from the registered incident light (120) which are characteristic for a display screen upon successful extraction of the specific frequency components by the filtering means (102), and compressing means (104) for adjusting operation of the device (100) in dependence on the output of the determining means (103).

The invention relates to a device arranged for context-aware operations.

Recent years have seen a great increase in subscribers world-wide to mobile telephone networks and, through advances in technology and the addition of functionalities, cellular telephones have become personal, trusted devices. A result of this is that a mobile information society is developing, with personalized and localized services becoming increasingly more important. Such “Context-Aware” (CA) mobile telephones communicate with low power, short range beacons in places like shopping malls to provide location-specific information. This information might include local maps, information on nearby shops and restaurants and so on. The user's CA device may be equipped to filter the information received according to pre-stored user preferences and the user is only alerted if an item of data of particular interest has been received.

There are many application scenarios where the typical information request will be highly dependent on the location and likely to be identical or similar for many requesters at that location. For example, a restaurant may want to announce its daily menu to every passer-by. Its owner can then install a beacon to provide the context-aware service to these passers-by. Information such as the logo of the restaurant, photographs of the interior, some music that suggests the style of experience a visitor would enjoy, the menu card with items like “today's specials”, and so on can then be broadcast to receiving devices in the vicinity of the beacon (and consequently, in the vicinity of the restaurant). A user can browse the information, request more information (like details on today's specials) and reserve a table for two for that evening.

Generally speaking, the user's context-aware device needs to be informed about its location relative to one or more other devices. This way, the device is capable of adjusting its operations to fit the context in which the device is introduced. There are many such context-aware operations. To name a few:
Screen ‘docking’ applications: any application wherein the proximity of a hand-held device to a display device triggers some action. For example, the user requests something of the application by holding his hand-held device near the display device. Content transfer between the hand-held and the display, and/or displaying parts of the user interface of the hand-held device on the display are now possible. See European patent application 01204905.2 (attorney docket PHNL010942) for more information.
Establishing the location of the screen device: in case the mobile device can establish its location, but the screen device cannot do that itself, the proximity between these two enables the application to infer the screen location from the mobile location.
Establishing the location of the mobile device: in case the screen position is known, the proximity of a mobile device implies the location of the mobile device.

There are several ways to obtain the required location and/or proximity information. Various tracking systems exist, some of them based on the Global Positioning System, with which the (absolute) location of a device can be determined. Given the location of the hand-held device and the display device, it is easy to determine whether they are relatively near each other. However, such tracking systems are quite expensive and require an extensive infrastructure, which makes them unacceptable for low-cost consumer electronics.

An alternative method is to embed positioning information in audio or video content by means of watermarking technology. A small video camera or microphone in the hand-held device can pick up the watermarked content and extract the embedded information. This is described e.g. in international patent application WO 03/001763 (attorney docket PHNL010421). This solution requires expensive detection hardware (camera or sensitive microphone) and a lot of algorithmic processing in the detecting device. Further, it is not very well-suited for real-time information unless the transmitting device is capable of real-time watermarking.

It is an object of the invention to provide a device according to the preamble, which is capable of determining a context in a cheap and reliable manner.

This object is achieved according to the invention in a device comprising a light sensor for registering incident light originating from an external light source, coupled to filtering means for extracting specific frequency components from the registered incident light which are characteristic for a display screen, determining means for determining the presence of an external display screen upon successful extraction of the specific frequency components by the filtering means, and processing means for adjusting operation of the device in dependence on the output of the determining means.

Since almost all types of display devices emit visible light, a light-sensitive sensor can be installed in the context-aware device which reacts to these display devices. This sensor can be of the LDR type, but it could also be a visible light or infrared photodiode. By analyzing the light incident upon the sensor, it is possible to determine whether the light source is in fact a display device, as opposed to a light bulb or natural light sources. If it is found that the light source is indeed a display device, the device according to the invention can adjust its operation accordingly.

The basis for this determination is formed by the extraction of specific frequency components which are characteristic for a display screen. This could be for example frequency components that correspond to the vertical refresh rate of the display screen (e.g. 50, 60, 85, 90 or 100 Hz), harmonics of the vertical refresh rate, or the horizontal refresh rate, and so on. The amplitude of the detected incident light is inversely proportional with the distance from the light source, so it follows that the light source must be relatively near if a successful extraction of the specific frequency components could be performed.

In an embodiment the device comprises embedding means for embedding an identifier for the device in an output signal to be displayed on a display screen. In response to the detection of an external display screen nearby, the device can transmit identifying information regarding itself. This way, the other party in the context-aware application can adjust the application to this particular device.

Preferably the embedding means are arranged to embed the identifier by modulating at least part of the output signal, for instance by modulating the brightness of the output signal in dependence on the identifier. Switching the brightness of the display between high and low according to a certain binary pattern (representing the device identifier) allows the device to transmit its identity. The other party in the context-aware application can pick up the variations in the brightness very easily and therefore derive the identity of the device.

In a further embodiment the determining means are arranged for obtaining an identifier for the external light source from the extracted frequency components. In many context-aware applications, knowing that a display device is present is not sufficient This embodiment advantageously allows the device to obtain the identity of the external display device. This identity could be derived e.g. from agreed-upon variations in the specific frequency components.

In a variation of this embodiment the device is coupled to a further light source, and comprises adjusting means for adjusting the light emitted by the further light source in dependence on the obtained identifier. This way the device can act as a repeater for the information embedded in the incident light.

Similarly, the determining means can be arranged for obtaining information regarding the position of the external light source from the extracted frequency components. Of course the information that can be transmitted using manipulation of the specific frequency components is not restricted to an identifier of the light source. Transmitting the position of the source can also be advantageous. Since a successful extraction indicated that the two devices are in relative proximity, the position of the light source can be assumed to be the same as the position of the device according to the invention. This determination of the position is accurate enough for many context-aware applications.

In a further embodiment the processing means are arranged for wirelessly broadcasting a communication request in response to detecting the presence of the external light source. The beacon can now pick up the communication request and start the context-aware application. This way, the beacon can be passive and does not have to constantly broadcast its own signals in case any hand-held devices are in the neighborhood. Further, the hand-held device now saves power, because it does not have to listen for any such broadcasts by the beacon, nor does it have to broadcast its presence itself all the time. It can simply wait for a successful detection, and then broadcast a single communication request, which can be picked up by the beacon.

These and other aspects of the invention will be apparent from and elucidated with reference to the embodiments shown in the drawings, in which:

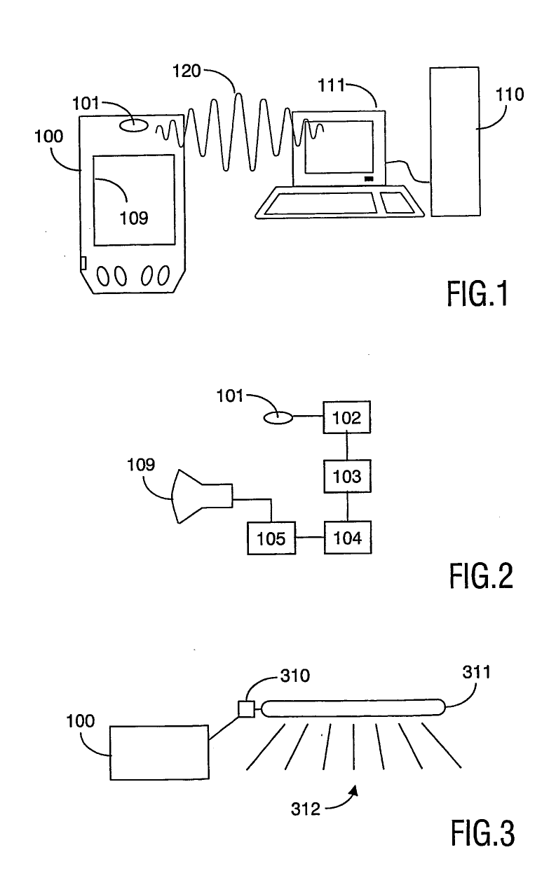

FIG. 1 schematically shows a first embodiment of the device;

FIG. 2 schematically shows this embodiment in more detail; and

FIG. 3 schematically shows a second embodiment of the device.

Throughout the figures, same reference numerals indicate similar or corresponding features. Some of the features indicated in the drawings are typically implemented in software, and as such represent software entities, such as software modules or objects.

FIG. 1 schematically shows a first embodiment of the device 100. A computer system 110 is arranged to provide context-aware applications to devices in its proximity. Several such applications have been described extensively in International patent application WO 02/076024 (attorney docket PHNL010194). For reasons of brevity they will not be repeated here.

The computer system 110 is coupled to a display device 111. In the embodiment shown the display device 111 comprises a conventional cathode ray tube (CRT) display, although it could equally well be an LCD screen or any other type of display screen. The display device 111 visually shows messages, e.g. animations or advertisements related to the context-aware applications. For example, the display device 111 could be installed in a shop window belonging to a store offering the context-aware applications.

When a passerby carrying the device 100 comes in the proximity of the display device 111, a light-sensitive sensor 101 in the device 100 picks up visual emissions 120 coming from the display device 11. This sensor can be of the LDR type, but it could also be a visible light or infrared photodiode. Of course this requires that there is a visual line of sight between the device 100 and the display device 111. The display device 111 might therefore display messages such as “Hold your hand-held device towards the screen for interactive services” to encourage passersby to make use of the context-aware applications.

The registered incident light is then processed by the device 100 to detect the presence of the display device 111. If the display device 111 is detected, the device 100 then adjusts its operation accordingly. This will become apparent below.

FIG. 2 shows the device 100 in more detail. The light sensor 101 is coupled to a filter bank 102. The filter bank 102 extracts specific frequency components from the registered incident light which are characteristic for a display screen. This could be for example frequency components that correspond to the vertical refresh rate of the display screen (e.g. 50, 60, 85, 90 or 100 Hz), harmonics of the vertical refresh rate, or the horizontal refresh rate, and so on. The amplitude of the detected incident light is inversely proportional with the distance from the light source, so it follows that the light source must be relatively near if a successful extraction of the specific frequency components could be performed.

A determining module 103 then receives the extracted specific frequency components from the filter bank 102 and determines the presence of an external display screen based upon said extracted specific frequency components. This determination could be as simple as verifying whether any components corresponding to common vertical refresh rates were found, or whether any harmonics thereof were found. An enhanced determination can be made by combining multiple such basic determinations.

A processor 104 then adjusts an operation of the device 100 in dependence on the output of the determining module 103. For instance, a message could be displayed that a display device 111 was found. If this display device 111 could be used to display e.g. a movie presently playing on the display screen 109 in the device 100, the user can then choose wheether to ‘transfer’ playback to the display device 111. This is described e.g. in European patent application 01204905.2 (attorney docket PHNL010942).

The device 100 may comprise an embedding module 105 for embedding an identifier for the device in an output signal to be displayed on the display screen 109. In response to the detection of an external display screen nearby, the device can transmit identifying information regarding itself so the computer system 110 can pick it up.

Preferably the embedding module 105 embeds the identifier by modulating at least part of the output signal, for instance by modulating the brightness of the output signal in dependence on the identifier. Switching the brightness of the display between high and low according to a certain binary pattern (representing the device identifier) allows the device 100 to transmit its identity. Alternatively, the identifier could be sent via infrared transmission or similar means.

The determining module 103 may, in addition to determining the presence of the display device 111, also process the extracted specific frequency components to obtain an identifier for the display device 111. This identity could be derived e.g. from agreed-upon variations in the specific frequency components.

Similarly, the determining module 103 may obtain information regarding the position of the display device 111 (or the computer system 110, depending on what is supplied this way) from the extracted frequency components. The processor 105 can now assume that the position of the display device 111 is the same as the position of the device 100. This determination of the position is accurate enough for many context-aware applications.

The processor 104 could also wirelessly broadcast a communication request in response to detecting the presence of the external light source, using e.g. Bluetooth or IEEE 802.11/802.11a or 802.11b or similar wireless communication standard. The computer system 110 can now pick up the communication request and start the context-aware application.

FIG. 3 schematically shows a second embodiment of the device 100, in which the device 100 is coupled to a light source comprising a fluorescent tube 311 and control hardware 310. Of course the light source can also be a light bulb or other light-emitting device, as long as the light 312 emitted by the source has some characteristic that can be adjusted by the control hardware 310. In the case of TL tubes, the intensity of the light can be modulated by interrupting the electrical power for a short time. This allows the encoding of information in the light 312 by means of pulse position modulation.

In this embodiment, the information obtained from the visual emissions 120 coming from the display device 111, as described above, is now encoded in the light 312. This way the device 100 acts as a repeating device for the information emitted by the computer system 110. Other devices like the device 100 of the embodiment of FIG. 1 can pick up the visual emissions 312 from the tube 311 and extract the embedded information.

The information obtained from the visual emissions 120 coming from the display device 111 can also be used as a basis to adjust the information to be encoded in the light 312. This way the invention can be used to e.g. automatically assign identifiers to a number of devices like device 100: the first one receives the number one, picks that as its own identifier and encodes the number two in the light 312. A second device receives this number two, picks that as its own identifier and encodes the number three in the light it will emit. This process continues until all devices have picked an identifier. Other configuration parameters can of course be synchronized in the same fashion.

It should be noted that the above-mentioned embodiments illustrate rather than limit the invention, and that those skilled in the art will be able to design many alternative embodiments without departing from the scope of the appended claims. For instance, many of the features of device 100 as described above can equally well be provided in device 110. The device 100 need not necessarily have a display screen 109.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A device arranged for context-aware operations, comprising a light sensor for registering incident light originating from an external light source, coupled to filtering means for extracting specific frequency components from the registered incident light which are characteristic for a display screen, determining means for determining the presence of an external display screen upon successful extraction of the specific frequency components by the filtering means, and processing means for adjusting operation of the device in dependence on the output of the determining means.

2. The device of claim 1, comprising embedding means for embedding an identifier for the device in an output signal to be displayed on a display screen.

3. The device of claim 2, in which the embedding means are arranged to embed the identifier by modulating at least part of the output signal.

4. The device of claim 3, in which said modulating comprises modulating the brightness of the output signal in dependence on the identifier.

5. The device of claim 1, in which the determining means are arranged for obtaining an identifier for the external light source from the extracted frequency components.

6. The device of claim 5, being coupled to a further light source, and comprising adjusting means for adjusting light emitted by the further light source in dependence on the obtained identifier.

7. The device of claim 1, in which the determining means are arranged for obtaining information regarding the position of the external light source from the extracted frequency components.

8. The device of claim 1, in which the processing means are arranged for wirelessly broadcasting a communication request in response to detecting the presence of the external light source.
